(19) United States
(12) Patent Application Publication
(10) Pub. No.: US 2024/0198475 A1
(43) Pub. Date: Jun. 20, 2024

(54) METHOD FOR ANALYZING A TOOL, AND MOBILE POWER TOOL

(71) Applicant: Hilti Aktiengesellschaft, Schaan (LI)

(72) Inventors: Dario BRALLA, Buchs (CH); Florian SCHMID, Buchs SG (CH); Serhey KHANDOZHKO, Buchs SG (CH); Ioannis PETOUSIS, Lachen SZ (CH); Giovanni BELLUSCI, Buchs (CH)

(21) Appl. No.: 18/288,323

(22) PCT Filed: Jun. 7, 2022
(86) PCT No.: PCT/EP2022/065436

§ 371 Date: Oct. 25, 2023

(30) Foreign Application Priority Data
Jun. 11, 2021 (EP) 21179075.3
Jun. 11, 2021 (EP) 21179079.5

(51) Int. Cl. B23Q 17/24; B23B 39/14; B25J 11/00; B25J 15/04; G06T 7/00; G06V 10/764; G06V 10/82

(52) U.S. Cl. CPC B23Q 17/2457; B23B 39/14; B23Q 17/249; B25J 11/0055; B25J 15/04; G06T 7/0004; G06T 2207/20081; G06T 2207/20084; G06T 2207/30164; G06V 10/764; G06V 10/82

(57) ABSTRACT

A method for using a tool, for example a drilling tool, a chiseling tool or a grinding tool, with a mobile power tool wherein the mobile power tool determines at least one property of the tool. A mobile power tool is also disclosed.

The invention relates to a method for using a tool with a mobile power tool. The invention also relates to a mobile power tool which is configured to hold a tool, for example a drilling tool or a chiseling tool. Tools used on construction sites are often subject to heavy wear. Worn tools can considerably reduce the productivity of work on construction sites. Even relatively minor damage, for example in the area of carbide cutting edges in the case of a rock drill, can lead to significantly longer drilling times or even to a total failure of the tool and corresponding time and financial costs.

The object of the present invention is therefore to offer a method and a mobile power tool that enable work on construction sites using a tool with particularly high productivity.

The object is achieved by a method for using a tool with a mobile power tool, wherein the mobile power tool determines at least one property of the tool.

The invention is based on the idea of monitoring a property of the tool, in particular a variable property. Depending on the characteristics of the property, the tool can then be reused, replaced, repaired and/or serviced, for example cleaned, in order to be able to ensure the highest possible productivity over the longest possible period of time. It is also conceivable to control the use of the tool depending on the specific property. For this purpose, for example, a rotation speed and/or an impact energy or the like of the mobile power tool can be controlled.

The tool can be, for example, a drilling tool, a chiseling tool, a grinding tool, a sawing tool or the like. The tool can be configured for machining rock, for example concrete or brick.

The method can be used particularly advantageously with a percussive tool, for example a chiseling tool and/or a hammer drilling tool. Similarly, the method can preferably be used with mobile power tools that allow percussive operation, for example chiseling operation and/or hammer drilling operation. The method can very particularly preferably be used with a hammer drilling tool and/or with a mobile hammer drilling machine.

The property can be, in particular, an amount of wear. The property can be a shape and/or a size, in particular a length and/or a diameter, of the tool. The property can also be a tool type.

The measurement can also take the form of a classification. The property can include, for example, at least one classification as a drilling tool, chiseling tool, grinding tool, or the like. Several, in particular different, variable and/or non-variable properties of the tool can preferably also be determined. For example, provision can be made to determine a type of tool and an amount of wear of the tool.

In preferred variants of the method, an image of the tool can be recorded by an image recording unit in order to determine the property.

In particular, an image of a working section of the tool can be recorded. The working section can be, for example, a tool head. The working section can be located on an end side of the tool. Recording the end side can therefore provide an image of a tool head of the tool.

The image can be two-dimensional. It can also be three-dimensional. For this purpose, the image recording unit can be designed as a 3D image recording unit. As an alternative or in addition, several images can be recorded, in particular from different perspectives. A three-dimensional image can then be determined from the plurality of images.

The image can be recorded telecentrically. In particular, the image can be recorded along a longitudinal axis of the tool, so that the recorded image can be evaluated in a particularly robust manner, in particular such that it is not or hardly susceptible to contamination, such as dust for example. The telecentric recording is also advantageous if a diameter of the tool is intended to be determined.

The robustness of the evaluation can be further improved by recording the image in a measuring chamber. In particular, the image can be recorded in front of a standardized background, with standardized lighting conditions and/or with high contrast.

Studies have shown that the image can preferably be recorded with an f-number of at least 5, particularly preferably of at least 11, in order to ensure the best possible depth of field.

Recording with a lower f-number, for example 2.8, is also conceivable. In this case, the property to be determined should relate to a narrowly defined section of the tool, in particular with regard to its depth, for example to at least one cutting edge instead of the entire tool head.

The image recording unit can be designed as a camera. A high resolution can be achieved in a cost-effective manner if the image recording unit is designed to record an intensity image. For this purpose, it can be designed as a black-and-white camera, for example.

It is also conceivable for the image recording unit to be designed to record an infrared image. Local temperatures and/or local temperature differences can be determined by recording an infrared image. Points of increased loading can then be determined from the local temperatures and/or temperature differences, for example after the tool has been inserted. Local temperature differences can form during use of the tool, for example. They can therefore correlate with local stresses on the tool, in particular on individual regions of the tool. It is therefore also conceivable to use the infrared image to determine the amount of wear on the tool.

The tool and/or the measuring chamber can be illuminated, in particular during recording. The illumination can be monochromatic or at least substantially monochromatic. For uniform illumination, it is conceivable to use a diffuser.

The method can also comprise measuring the position of the tool. For this purpose, the measuring chamber can have a tool position measuring unit. The position can be measured inductively and/or by means of a light barrier.

In preferred variants of the method, the image recording unit is calibrated. For example, a pose of the image recording unit is determined. The image recording unit can preferably be calibrated with an accuracy of 1 mm or less, for example approximately 0.1 mm. A calibration pattern, for example a checkerboard pattern, can be recorded by the image recording unit for calibration. This enables particularly cost-efficient calibration. Possible temperature effects can also be taken into account.

As an alternative or in addition to the calibration, a trainable image evaluation unit can be used to evaluate the recorded image. The trainable image evaluation unit can then be trained with a large number of images from tools.

The measurement accuracy can be further increased if the recorded image is corrected for errors. In particular, lens errors, aberrations, or the like can be corrected. A Brown-Conrady model can be used for correction. As an alternative or in addition, a magnification can also be determined. In particular, the ratio of pixels of the image per section, for example a number of pixels per mm, can be ascertained.

The tool often has at least one status indicator, for example a wear indicator. The status indicator can be formed, for example, on the tool head or along the side of the tool. In variants of the method, provision can then be made for an image of the status indicator to be recorded. The amount of wear of the tool, for example, can also be determined by evaluating such an image. The tool or at least the status indicator should preferably be cleaned, in particular freed from dust, before the image is recorded.

As an alternative or in addition, provision can be made in variants of the method for a working parameter to be measured during a working operation of the mobile power tool in order to determine the property. In the case of a drilling tool and/or a drilling machine, the working parameter can be, for example, drilling progress, drilling speed, drilling time or the like. The working parameter can also correspond to an operating mode, e.g. a percussion operation, a drilling operation or a drill-percussion operation.

The property can be determined using an acceleration sensor and/or using a force sensor. In particular, the working parameter can be determined using an acceleration sensor and/or using a force sensor. A value for the property can then in turn be determined from the working parameter.

The working parameter can correspond to an acceleration, in particular a longitudinal acceleration. The longitudinal accelerations can be accelerations along a longitudinal axis of the tool and/or the mobile power tool.

Therefore, the accelerations triggered by the impacts can be measured, particularly in the case of a percussive mobile power tool.

The measured accelerations can also relate to the activity of the mobile power tool, in particular in relation to the impact activity.

The property can particularly preferably be determined in the form of a classification. This allows interference, for example due to other effects such as different backgrounds or the like, to be minimized.

The classification can include, for example, the classes “drilling tool” and “chiseling tool”. The classification can therefore relate to the type of tool.

It is conceivable for a trainable classifier to be used in order to determine the property. The trainable classifier can be and/or comprise, for example, a support vector machine (hereafter: SVM), a neural network, a principal component analysis unit or the like.

Particularly preferably, at least two different properties of the tool can be determined in parallel. Such multiple use of the same acceleration data allows the outlay on production for the mobile power tool to be reduced. It is therefore conceivable to determine the type of tool and its size in parallel using the same acceleration data. Sensors for the separate determination of these properties can therefore be saved, at least in part.

In order to optimize the control of a work process, for example a drilling process, of the mobile power tool, the at least one property can correspond to the type of tool and/or the size, in particular a diameter, of the tool.

In order to improve the accuracy of the determination, that is to say the measurement accuracy, of the property, at least one further piece of measurement data can be used in addition to the measured accelerations. In particular, a phase angle and/or a phase velocity can be used to determine the property. Here, the phase angle and/or the phase velocity can relate, for example, to a position or a speed of a motor and/or an eccentric of the mobile power tool.

It is also conceivable to determine information about the substrate or other characteristic values about the tool from the measured accelerations and/or from the current consumption and/or the voltage of the motor.

It is also conceivable to use a position detection unit as an alternative or in addition, for example in order to determine a drilling speed, drilling depth and/or the like. For this purpose, the position detection unit can be configured to detect, for example, a change and/or a speed of change in the position of the tool, in particular directly and/or indirectly.

A power tool which has an acceleration sensor, a force sensor and/or a position detection unit can be used for this purpose.

A trainable filter can be used in order to determine the property. The trainable filter can comprise, in particular, a neural network, for example a deep learning unit, a support vector machine or the like.

In order to determine the wear property as a property, the trainable filter can be trained with data from fully functional, worn and damaged tools. The training can be performed with single image data. Training can preferably also be carried out with video data. The video data can show, for example, rotating tools.

The method can be used particularly preferably by way of determining the property of the tool on a construction site, in particular on a structural engineering construction site, a civil engineering construction site and/or a prefabrication construction site. A prefabrication construction site can correspond to a work region outdoors and/or in a building where a component for use in or on a building, for example a prefabricated component, in particular a wall, floor or ceiling element, is produced.

From what has been described above, it also follows, in particular, that the working parameter can be measured during working operation of the mobile power tool in order to determine a first property and an image of the tool can be recorded by the image recording unit in order to determine a second property, in particular an amount of wear.

In particular, the second property can be determined when the first property reaches or is in a critical value range.

An advantageous example of this arises in particular when a drilling tool is checked using the image recording unit as soon as an excessively low drilling speed is established, in particular using the acceleration sensor and/or the force sensor.

For example, a construction task can involve drilling one or more holes on a construction site. The mobile power tool can then measure the working parameter while drilling at least one of the holes to be drilled, for example using the acceleration sensor and/or the force sensor.

For example, the working parameter can correspond to a type of substrate to be worked, in particular rock such as e.g. concrete versus metal and/or metal alloys, for example rebar. The tool, in particular the drilling tool, can then be checked for wear using the image recording unit at specific intervals that depend, for example, on the detected type of substrate.

As an alternative or in addition, it is also conceivable for a working parameter, for example drilling progress, the occurrence of specific accelerations, a frequency spectrum of accelerations, a drilling speed or the like, to be measured as a working parameter.

Depending on the measured working parameter, in particular when the working parameter reaches a critical level, for example corresponding to critical wear, the amount of wear can then be determined using the image recording unit, in particular in the measuring chamber. Measures appropriate to wear can then be taken. For example, the tool can continue to be used without change, cleaned and/or replaced.

One advantage of such an approach is to avoid unnecessary interruptions in work, such as drilling. In particular, this can lead to a considerable acceleration when the measuring chamber and/or the image recording unit are located at a certain distance from the working position, for example the drilling position.

The scope of the invention also covers a mobile power tool, for example a hand-held power tool or a construction robot, which is configured to hold a tool, for example a drilling tool, a chiseling tool or a grinding tool, wherein the mobile power tool is configured to determine at least one property of the tool held in it. Here, “held in it” can also mean that the tool is held in a tool storage device which interacts with the mobile power tool. It can also include the tool being held in a tool fitting of the mobile power tool.

It is particularly preferred when the mobile power tool is and/or comprises a construction robot. The construction robot can be configured to carry out construction work autonomously or at least partially autonomously. For example, it can be a drilling construction robot, a chiseling construction robot and/or a grinding construction robot. As an alternative, the mobile power tool can also be a hand-held power tool, for example a hand drill, a hammer drill, a portable chiseling machine or the like.

Particularly when the construction robot has a high degree of autonomy, it is expedient if the construction robot can determine the property of the tool, for example the amount of wear, independently. For example, during drilling work in steel-reinforced concrete components, a drilling tool can break. The mobile power tool according to the invention, in particular in the form of the drilling construction robot, is therefore able to repeatedly check the tool used and, in the event of heavy wear and/or damage to the tool, to interrupt planned construction work, in the present example planned drilling work, to replace the tool and/or to stimulate a user interaction from a user of the mobile power tool.

In one class of embodiments, the mobile power tool can be configured to detect a type and/or an amount of wear of the tool held.

It can also be configured to measure a working parameter.

The mobile power tool particularly preferably has an acceleration sensor.

For this purpose, the acceleration sensor can be arranged on a motor and/or on a transmission of the mobile power tool. It can therefore be configured to detect accelerations and/or vibrations of the motor and/or the transmission.

The mobile power tool can also have a force sensor. The force sensor can be configured, for example, to detect a contact-pressure force, for example a force with which the tool presses against the substrate. The force sensor can also be configured to measure a torque, in particular by measuring a tangential force.

The acceleration sensor, the force sensor and/or the position detection unit can also be configured to detect a blockage of the tool, for example jamming in the case of a drilling and/or chiseling tool.

The mobile power tool can also be configured to detect a type, a state and/or a change in the state, for example by evaluating accelerations detected by the acceleration sensor, for example in the form of vibrations, in particular in the range of infrasound, audible sound and/or ultrasound.

The mobile power tool can preferably be configured to output a signal to a user, in particular directly and/or indirectly, depending on the specific property. For example, the signal can indicate a degree of wear and/or prompt the user for a user interaction. In this way, the user can be alerted to a worn tool. They can then be asked, for example, to indicate whether pending construction work should be interrupted and/or whether the tool should be replaced. As an alternative or in addition, the mobile power tool can be configured to interrupt the construction work until a defect on or in the tool has been remedied, for example in the case of a worn or damaged tool.

The mobile power tool can particularly preferably have at least one image recording unit. The image recording unit can be configured to record an image of the tool. It can have one or more of the properties described above in connection with the method. For example, it can be configured to record an intensity image, for example in the form of a black-and-white image, and/or a color image.

The mobile power tool can particularly preferably be configured to determine the property of the tool to be determined using the recorded image.

The mobile power tool can have, in particular, a measuring chamber. The tool for determining the property can be held at least partially in the measuring chamber.

The mobile power tool can further be configured to automatically set one of its operating parameters, for example a rotation speed and/or an impact energy, depending on the detected type and/or depending on the detected state.

Embodiments of the invention that can be used particularly flexibly can be configured for the use of different types of tools. For example, the mobile power tool can be configured for operation with at least two different tools from the group comprising drilling tools, chiseling tools, grinding tools and measuring tools.

If the mobile power tool has a tool changer, it can be configured to automatically select and/or replace a tool to be used.

The mobile power tool can particularly preferably have a tool cleaning apparatus. The tool cleaning apparatus can be configured, in particular, to remove dirt, for example dust. The tool can therefore be cleaned automatically after use. The measurement accuracy can also be increased by measuring the property to be measured after cleaning the tool.

The mobile power tool can preferably be a construction robot, in particular a drilling construction robot.

The mobile power tool can be configured to determine the property of the tool using the method described above.

The scope of the invention also covers a mobile power tool, for example a hand-held power tool or a construction robot, which is configured to hold a tool, for example a drilling tool or a chiseling tool, wherein the mobile power tool is configured to determine at least one property of the tool held in it according to the method described above.

For this purpose, the mobile power tool can also have one or more of the properties of the mobile power tools described above.

In general, the mobile power tool can be configured to implement the method described above.

In particular, it can be configured to detect a first property, in particular using the acceleration sensor, the force sensor and/or the position detection unit, while construction work is being carried out, for example while drilling a hole.

Particularly if the tool is a drilling tool, the mobile power tool can be configured to check the drilling tool using the image recording unit, in particular for wear, as soon as an excessively low drilling speed is established, in particular using the acceleration sensor, the force sensor and/or the position detection unit.

It is also conceivable to carry out the check at intervals using the image recording unit, in which case the length of the intervals can depend on the first property.

The mobile power tool can have a communication interface for data transmission with at least one remote computer unit. The communication interface can be configured, in particular, for wireless data transmission.

In particular, the communication interface can be configured to transmit at least one value of a specific property. As an alternative or in addition, the communication interface can be configured to receive data and/or program code from the remote computer unit. In particular, it is conceivable for calibration data, for example for calibrating the determination of the property of the tool, training data and/or calibration parameters of the trainable filter to be able to be received by means of the communication interface. In this way, the determination of the property can also be further improved after delivery of the mobile power tool, for example on the basis of improved training data.

It is also conceivable for use data, in particular data relating to the specific properties of the tool, to be collected and evaluated in the remote computer unit. This also allows improved control of construction tasks.

The measurement data, in particular the accelerations, can be evaluated within the mobile power tool and/or outside it. Particularly in the case of a mobile power tool designed as a construction robot, it is conceivable for a power tool, for example a drilling apparatus, to be arranged on a working arm of the mobile power tool and for the evaluation to take place in a computer unit which is separated from the power tool. The computer unit can then be part of the mobile power tool, i.e. of the construction robot, and/or part of a remote computer system, for example a cloud-based computer system.

The acceleration sensor can preferably be arranged in the vicinity of the working axis and/or the longitudinal axis of the power tool. The distance from the working axis and/or the longitudinal axis can preferably be less than 10 cm. In particular, the distance can be at most 3 cm, for example 2.5 cm. For this purpose, the acceleration sensor can be arranged on a transmission housing. In particular, it can be arranged outside other power tool electronics in order to be exposed to the strongest possible accelerations or vibrations to be measured.

The bandwidth of the vibrations can be at least 500 Hz, particularly preferably at least 900 Hz.

The acceleration sensor can comprise and/or be a MEMS (microelectromechanical system) sensor.

It is also conceivable to control the mobile power tool depending on the specific property of the tool. For example, the mobile power tool can be configured to set a power output and/or impact energy depending on the specific type and/or size of the tool. In this way, excessively rapid wear can be avoided, particularly during working operation.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combinations in variants of the invention.

Exemplary embodiments of the invention are shown in the schematic drawing and explained in more detail in the following description.

In the drawing:

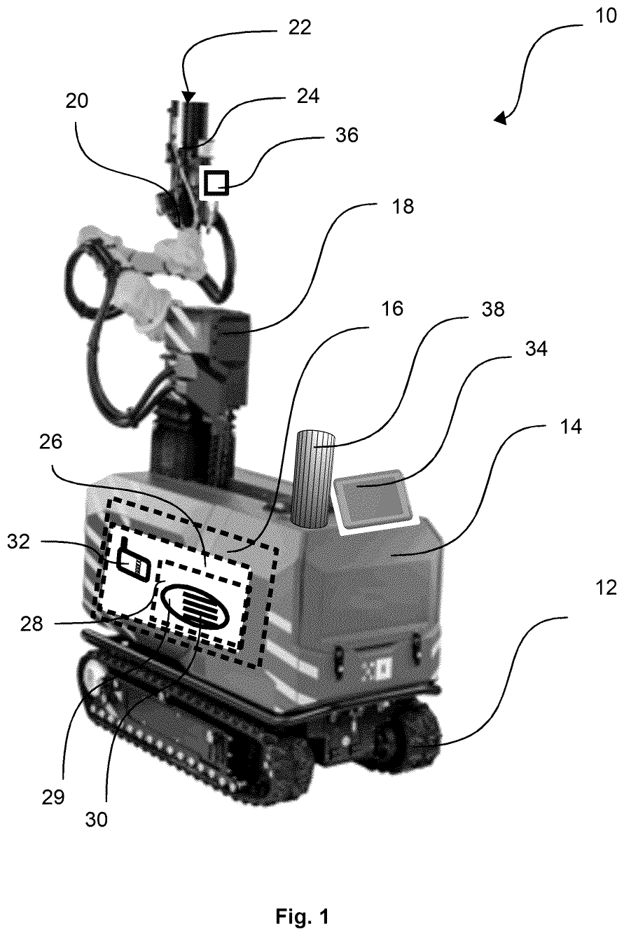

FIG. 1 shows a schematic illustration of a construction robot:

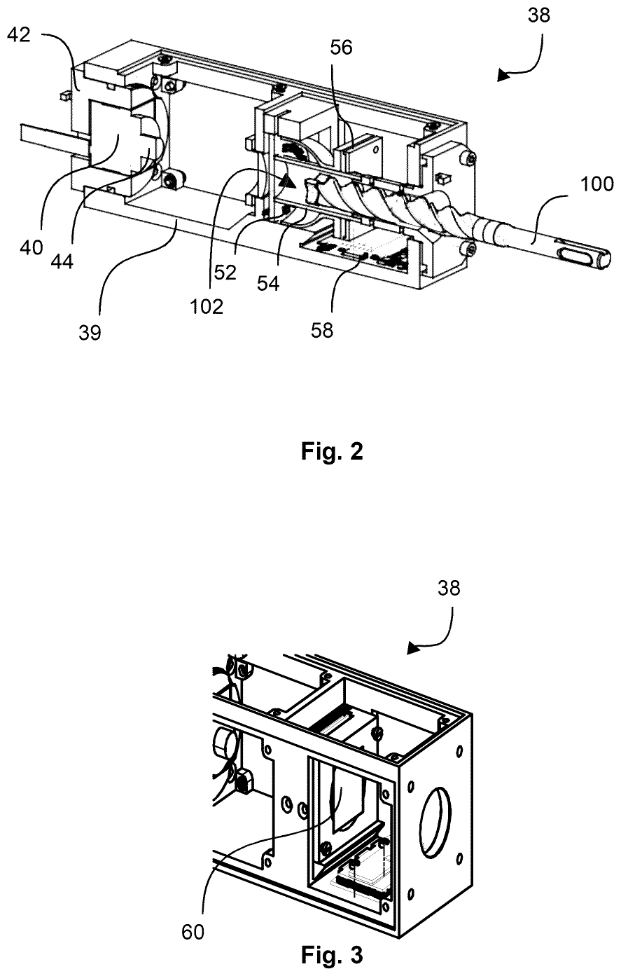

FIG. 2 shows a perspective sectional view of a measuring chamber:

FIG. 3 shows a perspective sectional view of a measuring chamber during calibration:

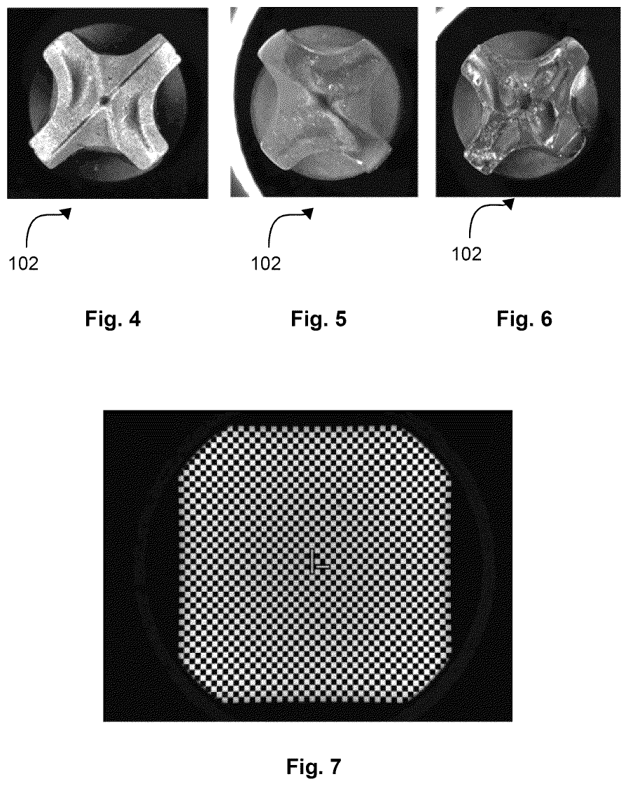

FIGS. 4 to 6 shows images of tools with different degrees of wear: and

FIG. 7 shows an image of a calibration pattern.

In order to make it easier to understand the invention, the same reference signs are used in each case for identical or functionally corresponding elements in the following description of the figures.

The invention is explained in more detail using the example of a mobile power tool designed as a drilling construction robot.

FIG. 1 shows a drilling construction robot 10 with a running gear 12 designed as a tracked running gear, a control space 16 formed in a housing 14 and a manipulator 18 arranged on the top side of the housing 14. The manipulator 18 is designed as a multiaxially controllable arm, at the free end of which an end effector 20 with a drilling power tool 22 arranged thereon and preferably a dust extraction apparatus 24 is arranged.

The drilling construction robot 10 is designed for performing construction tasks, in particular drilling work in ceilings and walls, on a construction site, for example on a structural engineering construction site. In addition to the manipulator 18 for performing the construction tasks assigned to the drilling construction robot 10, it has a computer unit 26 arranged within the housing 14, in particular in the control space 16. The computer unit 26 comprises a memory unit 28.

The computer unit 26 is equipped with executable program code, so that an internal construction task management system 29 with an internal construction task list 30, which comprises one or more construction tasks to be performed by the drilling construction robot 10 on the construction site, is formed by means of the computer unit 26. For this purpose, the internal construction task list 30 is stored in the memory unit 28 in a retrievable manner.

A deep learning unit in the form of a neural network is also formed on the computer unit 26 using the program code. As explained in more detail further below, the deep learning unit is first trained and then used to determine one or more properties of a tool from recordings of images.

The computer unit 26, and consequently the drilling construction robot 10, further have a communication interface 32 for communication with an external construction task management system, the external construction task management system being configured to store an external construction task list in a retrievable manner, the external construction task list comprising one or more construction tasks to be performed on the construction site, the drilling construction robot 10 being configured to send at least one construction task and/or a construction task status of a construction task of the internal construction task list 30 to the external construction task management system via the communication interface 32.

The communication interface 32 has a cellular interface according to the 4G or the 5G standard, a WLAN interface, a Bluetooth interface and a USB interface for data transmission using portable USB storage units.

Since the computer unit 26, the memory unit 28, the internal construction task management system 29, the internal construction task list 30 and the communication interface 32 are arranged in the control space 16 and therefore within the housing 14, these, including the control space 16, are schematically shown in FIG. 1.

The drilling construction robot 10 further has a display unit 34, which is designed as a touchscreen. Consequently, the display unit 34 at the same time forms an input unit for manual data input by a user of the construction robot 10. In particular, the display unit 34 is configured in connection with the computer unit 26 and the internal construction task management system 29 to graphically display the construction tasks contained in the internal construction task list 30, including the construction task statuses assigned to the construction tasks.

For this purpose, the display unit 34 is configured to schematically display the construction site or at least a relevant part of the construction site and to graphically display the construction tasks to be carried out by the drilling construction robot 10, here drilling, according to the spatial arrangement of the construction tasks in the form of appropriately positioned circles. Depending on the associated construction task status, in this case depending on the respective degree of completion, the circles are shown filled with different colors. The construction tasks as well as the respectively assigned construction task statuses can also be changed manually by the user.

A position detection unit 36 for determining the position and the location of the manipulator 18, and consequently of the construction robot 10, is formed on the end effector 20.

The drilling construction robot 10 is further configured to send the position and location of its manipulator 18 determined by means of the position detection unit 36 via the communication interface 32 and to receive corresponding position and location data from other drilling construction robots.

The drilling construction robot 10 further has a measuring chamber 38, shown schematically in FIG. 1.

The measuring chamber 38 is configured to hold a tool, here a drilling tool to be used by the drilling power tool 22, at least one property of which is to be determined. The measuring chamber 38 is configured in such a way that the drilling tool can be introduced into the measuring chamber 38 using the manipulator 18 and its end effector 20 for the measurement.

The drilling construction robot 10, in particular its computer unit 26 and here particularly the program code, is configured to determine a type of drilling tool, a size of the drilling tool and its state of wear using the measuring chamber 38 before starting a construction task or at least before starting a series of construction tasks. As an alternative or in addition, the drilling construction robot 10 can also be configured to check the drilling tool used using the measuring chamber 38 during or after carrying out a construction task, that is to say during drilling.

In particular, it is conceivable to check the drilling tool as soon as the drilling construction robot 10 detects, for example, an excessively low drilling speed.

In particular, the drilling construction robot 10 is configured to check whether the correct drilling tool required for the respective construction task is present. Said drilling construction robot is further configured to check that the drilling tool is in an operational state and for this purpose is, in particular, neither badly damaged nor excessively worn. In particular, a check is made as to whether the drilling tool, in particular its cutting edges, is/are moving within permissible tolerance ranges.

The drilling construction robot 10 can contain a tool storage device with several suitable replacement drilling tools, so that the drilling construction robot 10 can automatically replace the drilling tool with a replacement drilling tool in the event of damage or excessive wear and/or in the event that it is unsuitable for the respective construction task.

FIG. 2 shows a schematic, perspective sectional view of the measuring chamber 38, into which a drilling tool 100 is introduced by way of its tool head 102 for measurement purposes. The measuring chamber 38 has a housing 39.

The measuring chamber 38 further has an image recording unit in the form of a measuring camera 40. The measuring camera 40 is designed as a black-and-white camera. It has a resolution of at least 3 MP, preferably at least 5 MP. For recording image sequences, in particular videos, it has an image recording rate of at least 5, preferably at least 7, frames per second. The measuring camera 40 is held by a camera holder 42.

A lens 44 with a focal number of 11 is arranged in the beam path in front of the measuring camera 40. For fine adjustment of the position of the measuring camera 40, the position of the camera holder 42 can be finely adjusted relative to the housing 39 by means of spacer elements.

A lens holder 46 further fixes a lens, in particular a plano-convex lens 48 in the beam path in front of the measuring camera 40. The lens 48 has an effective focal length of 75 mm.

In the further course of the beam path, there is a protective glass 50, in particular with a thickness of approximately 3 mm, through which the tool head 102 of the drilling tool 100 can be seen from the measuring camera 40.

In particular, the measuring camera 40 can therefore record an image of a front view of the tool head 102.

The tool head 102 can be illuminated by means of a, preferably annular, lighting device 52. The lighting device 52 is equipped with a large number of LEDs. It is configured to generate monochromatic or at least substantially monochromatic light, for example green light, so that lens errors, such as chromatic aberrations for example, have only minor effects on the recorded image. In order to achieve illumination that is as uniform as possible and, for example, to avoid highlights on the tool head 102, the illumination device can be equipped with one or more diffusers. The lighting device 52 also has a lighting dome in order to achieve the most homogeneous possible illumination from a large solid angle. For this purpose, the lighting dome can be formed from a matt white material.

A separating tube 54, in which the drilling tool 100 is arranged by way of its tool head 102, is of transparent design in order that the light generated by the lighting device 52 can reach the tool head 102. It can be formed from a transparent plastic, for example.

A light barrier 56 is arranged in the region of the separating tube 54, so that it is possible to detect whether the drilling tool 100 has been inserted into the measuring chamber 38 and in particular whether it has been inserted far enough into the separating tube 54.

Furthermore, preprocessing electronics 58, in particular with interface electronics for communicating with the computer unit 26 (see FIG. 1), can be arranged inside the housing 39.

FIG. 3 shows a refinement of the measuring chamber 38 in order to calibrate the measuring camera 38. In particular, it can be seen that a calibration pattern 60 can be provided instead of the drilling tool 100. The calibration pattern 60 can be, for example, a checkerboard pattern, not shown in the illustration according to FIG. 3, as is shown in FIG. 7 in the form of a raw recording by way of example.

The calibration pattern 60 can have a dimensionally stable opal glass substrate, for example with an etched blue chrome checkerboard pattern. The checkerboard field sizes can be 0.4 mm×0.4 mm, preferably with an accuracy of better than 0.005 mm.

Before using the measuring chamber 38 to measure the tool head 102, in particular the distances of the lens 44 from a sensor surface of the measuring camera 40 and of the sensor surface from the lens 48 are calibrated. Furthermore, the telecentricity of the arrangement is calibrated.

For this purpose, images can be recorded iteratively by the measuring camera 40 and the distances can be adapted in each case as a function of the images recorded.

Furthermore, lens distortions are corrected as part of the calibration. In particular, a second-order tangential Brown-Conrady distortion model is applied to the image coordinates. The Brown-Conrady model corrects for both radial distortions and tangential distortions caused by physical elements in a lens that are not perfectly aligned, causing a recorded image of the checkerboard pattern to appear square and evenly distributed. Distortion correction parameters are estimated from a raw image of the calibration pattern 60.

Furthermore, parallel to the correction of the lens distortions, the ratio between the image size, in particular the number of pixels, and the actual size, measured in mm for example, is also determined.

Depending on the materials used for the measuring chamber 38, there can be a more or less pronounced temperature dependency. Therefore, the measuring chamber 38 can also be equipped with a temperature sensor. Recorded raw images can then additionally be corrected for temperature effects.

In addition to the calibration, there is a further preparatory step in the training of the deep learning unit formed by means of the computer unit 26 (see FIG. 1).

For this purpose, the training takes place by means of recordings of tool heads 102 of different drilling tools 100, in particular of fully functional, partially worn and damaged drilling tools 100.

Examples of such recordings of such tool heads 102 are shown in FIG. 4 (fully functional), FIG. 5 (partially worn) and FIG. 6 (damaged).

In particular, video recordings, i.e. sequences of individual images, of the respective tool heads 102 are recorded by means of the measuring camera 40 (FIG. 1). During the video recordings, the tool heads 102 are slowly rotated so that at least one rotation is fully recorded in each case.

The underlying classification of the tool heads 102 can be performed by expert ratings.

It has been shown that the deep learning unit extracts, among other things, features from the images similar to a high-pass filter.

Within the framework of our own investigations, approximately 98% of the drilling tools 100 to be replaced, i.e. damaged or badly worn drilling tools, were able to be correctly classified as requiring replacement. Approximately 96% of the fully functional drilling tools 100 were able to be correctly classified as fully functional.

A further improvement in the classification accuracy is conceivable by way of classification being carried out on the basis of more than one image, by way of additional cleaning being carried out and/or by way of at least one additional working parameter, such as drilling speed or drilling duration, being used for the classification.

After the calibration is complete, an actual measurement process can take place.

According to the method, the drilling tool 100 can be inserted into the measuring chamber 38 with its tool head 102 in front for this purpose.

After detecting the correct positioning using the light barrier 56, the measuring camera 40 records an image of the tool head 102 illuminated by the lighting device 54.

The data of the recorded image is transmitted to the computer unit 26 via the preprocessing electronics 58 and the interface electronics integrated in these.

By executing the program code on the computer unit 26, the data of the recorded image is first pre-processed, in particular image errors such as distortions and the like are corrected in accordance with the calibration described above.

Subsequently, its diameter is first determined as a property of the drilling tool 100.

For this purpose, the adjusted data of the image is filtered through a median filter in order to reduce the influence of noise and/or dust particles.

In a next step, edges are determined using a Canny edge detection algorithm, for example. A largest connected region is then ascertained. A convex hull algorithm is applied to the filtered data. The diameter to be determined is then ascertained by means of a rotating caliper algorithm.

An amount of wear in the form of a classification into one of the three previously trained classes is then determined as a further property of the drilling tool 100.

For this purpose, the adjusted image is first cropped to relevant areas in order to eliminate disruptive information, e.g. any mapping of the separating tube 54 in the image. It goes without saying that the image data used for the training described above can also be tailored in the same way.

The data obtained in this way is fed into the deep learning unit and thereby classified into one of the trained classes.

As a result, if the drilling tool 100 is classified as being replaceable, i.e. as being worn or damaged, the drilling robot 10 outputs a corresponding signal to a user, for example using the display unit 34 (see FIG. 1).

In alternative embodiments of the drilling construction robot 10, in which the drilling construction robot 10 comprises a tool changer and/or a tool storage device with replacement drilling tools, provision can alternatively or additionally be made for the drilling construction robot 10 to automatically replace the drilling tool 100 in this case, so that the drilling tool 100 to be used then can be regarded as being fully functional again.

In the event that the drilling tool 100 is fully functional, the drilling construction robot 10 can be configured to start or possibly continue a construction task, in this case drilling.

1. A method for using a tool with a mobile power tool, wherein the mobile power tool has a measuring chamber in which the tool can be at least partially held in order to determine at least one property, the method comprising determining the at least one property of the tool by the mobile power tool.

2. The method according to claim 1, comprising determining a tool type, a size and/or an amount of wear as the at least one property.

3. The method as claimed in claim 1, comprising recording an image of the tool by an image recording unit to determine the at least one property.

4. The method as claimed in claim 1, comprising recording an image of a working section of the tool.

5. The method as claimed in claim 1, comprising measuring a working parameter is measured during working operation of the mobile power tool to determine the at least one property.

6. The method as claimed in claim 1, comprising determining the at least one property using an acceleration sensor, a force sensor and/or a position detection unit.

7. The method as claimed in claim 1, comprising using a trainable filter to determine the at least one property.

8. The method as claimed in claim 1, comprising training the trainable filter with data from fully functional, worn out and damaged tools.

9. The method as claimed in claim 1, comprising determining the at least one property of the tool on a construction site.

10. The method as claimed in claim 1, comprising measuring a working parameter during working operation of the mobile power tool to determine a first property and recording an image of the tool by the image recording unit to determine a second property.

11. The method as claimed in claim 10, comprising determining the second property when the first property reaches or is in a critical value range.

12. The method as claimed in claim 10, comprising checking a drilling tool using the image recording unit as soon as an excessively low drilling speed is established.

13. A mobile power tool which is configured to hold a tool, the mobile power tool having a measuring chamber in which the tool can be at least partially held in order to determine at least one property, wherein the mobile power tool is configured to determine the at least one property of the tool held in it.

14. The mobile power tool as claimed in claim 13, wherein the mobile power tool has at least one image recording unit.

15. (canceled)

16. The mobile power tool as claimed in claim 13, wherein the image recording unit is arranged in the measuring chamber and/or adjacent to the measuring chamber.

17. The mobile power tool as claimed in claim 13, wherein the mobile power tool has an acceleration sensor, a force sensor and/or a position detection unit.

18. The mobile power tool as claimed in claim 13, wherein the mobile power tool is configured to automatically set an operating parameter, for example a rotation speed and/or an impact energy, depending on the detected type and/or depending on the detected state.

19. The mobile power tool as claimed in claim 13, wherein the mobile power tool has a tool cleaning apparatus.

20. The mobile power tool as claimed in claim 13, wherein the mobile power tool is a construction robot.
